(19) United States
(12) Patent Application Publication
(10) Pub. No.: US 2005/0229240 A1
(43) Pub. Date: Oct. 13, 2005

(54) Information processing apparatus, authentication processing program, and authentication storage apparatus

(75) Inventor: Katsushi Nanba, Nagoya (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/925,213

(22) Filed: Aug. 25, 2004

(30) Foreign Application Priority Data
Apr. 8, 2004 (JP) 2004-114196

(51) Int. Cl. H04K 1/00

(52) U.S. Cl. 726/6

(57) ABSTRACT

An information processing apparatus, comprises: an authentication information obtaining unit that obtains authentication information from an authentication storage apparatus when code information input by a user matches established code information; a storage unit that stores established authentication information; an authentication unit that performs authentication by comparing the authentication information and the established authentication information; an authentication information generating unit that generates new authentication information; and an authentication information updating unit that updates the authentication information of the authentication storage apparatus and the established authentication information of the storage unit into new authentication information when the authentication by comparing the authentication information with the established authentication information is normal.

### BACKGROUND OF THE INVENTION

The present invention relates to an authentication technique.

Up to now, there have been known techniques for performing computer logon authentication by using a card that is provided with a storage medium, such as an IC card, for example. In this case, a user registers, in the IC card, information including an ID and a password necessary for logon authentication.

It should be noted that the techniques that are disclosed in Patent documents 1 through 4 below, for example, exist as prior art relating to the present invention.

[Patent document 1] JP 2001-337930 A

[Patent document 2] JP 63-311493 A

[Patent document 3] JP 2001-308850 A

[Patent document 4] JP 11-203247 A

Problems shown below arise with the techniques described above.

For example, with the conventional techniques a user needs to conceive a new password every time password is changed, and to remember the password. Accordingly, it is a burden for the user to frequently change the password.

Techniques of automatically generating a password have thus been developed as methods of resolving the burden on the user when changing the password. However, although the majority of the techniques automatically generate passwords, a request from the user is necessary in order to change the password for cases where a password is to be changed. Further, in such techniques, the user must manually change the automatically generated password as changed password according to a password change request from a computer.

Further, there is a problem with the techniques as to how to notify the user about an automatically generated password without the password leaking to a third party.

In addition, some techniques exist among the conventional authentication techniques, in which the password that is automatically generated by the computer is used, as is, as the changed password. However, it is necessary for an administrator to intervene in automatic generation of passwords and in notification of change requests in the majority of the techniques.

Thus, there are many cases with the conventional authentication techniques where operations by the administrator or the user are necessary when changing the password. Therefore, for cases where the user has a low awareness of security, there is a concern that security will decrease due to causes such as the user not periodically performing password modification work or the user not registering the password that has been automatically generated.

Further, the majority of authentication systems have screens that prompt the user to input an ID and a password in password updating or changing with the conventional authentication techniques. A problem is thus a concern in that the password is made known to another person because of the existence of the password input screen with the conventional authentication techniques, due to causes such as those described below.

That is, there is a possibility that the user will make a new password known to another person when inputting a new password with the conventional authentication techniques. For example, there are cases with the conventional authentication techniques where the user may leave his or her seat in the middle of changing the password, or where the user may abort password change operations while changing the password, thus making the password known to another person.

In addition, there are cases with the conventional authentication techniques where another person attempts to intrude the system by checking the timing when the computer issues a password update notification.

### SUMMARY OF THE INVENTION

The present invention has been made in view of the items. An object of the present invention is to provide an authentication technique that can perform generation of robust authentication information without making the user aware of this. Further, another object of the present invention is to provide an authentication technique that can perform reliable management of authentication information without making the user aware of this. In addition, another object of the present invention is to provide an authentication technique that can perform authentication information generation and modification processing without making another aware of this.

In order to achieve the object, the present invention is characterized by comprising: an authentication information obtaining unit that obtains authentication information from an authentication storage apparatus for cases where code information input by a user matches established (authorized) code information; a storage unit that stores established authentication information; an authentication unit that performs authentication by comparing the authentication information and the established authentication information; an authentication information generating unit that generates new authentication information; and an authentication information updating unit that updates the authentication information of the authentication storage apparatus and the established authentication information of the storage unit into new authentication information for cases where the authentication by comparing the authentication information with the established authentication information is normal.

According to the present invention, it is possible to provide an authentication technique that can perform reliable management of authentication information without making the user aware of this.

Further, according to the present invention, it is possible to provide an authentication technique that can perform generation of robust authentication information without making the user aware of this. In addition, according to the present invention, it is possible to provide an authentication technique that can perform authentication information generation and modification processing without making another aware of this.

Further, the present invention is characterized in that the authentication information updating unit periodically updates the authentication information.

Further, the present invention is characterized in that the authentication storage unit stores plural pieces of the authentication information.

Further, the present invention is characterized in that the authentication information is authentication information necessary for using the information processing apparatus.

Further, the present invention is characterized in that the authentication information is authentication information necessary for using a program to be executed by the information processing apparatus.

Further, the present invention is characterized in that the authentication information is authentication information necessary for using a program to be executed by another information processing apparatus with which the information processing apparatus can communicate.

Further, the present invention is characterized in that the authentication storage apparatus is a portable storage medium that can be mounted to and removed from a reading apparatus.

Further, the present invention is characterized in that an instruction to mount the portable storage medium to the reading apparatus is issued to the user for cases where the authentication information updating unit performs updating.

It should be noted that the present invention may be a program for implementing any one of the functions described above. Further, the present invention may record such a program on a storage medium readable by a computer. Furthermore, the present invention may be an authentication storage apparatus that is connected to a computer performing any one of the functions described above and performs authentication processing on the computer.

### DESCRIPTION OF THE DRAWINGS

FIG. 1 is a basic functional block diagram of a logon portion at the startup of an OS that is basic software of a computer in a system to which an embodiment of the present invention is introduced.

FIG. 2 is a schematic diagram of conventional logon processing of an OS of a computer.

FIGS. 3A and 3B are diagrams showing an example of a logon screen according to an embodiment of the present invention.

FIGS. 4A and 4B are diagrams showing an example of a logon screen in accordance with a security module.

FIGS. 5A and 5B are diagrams showing an example of a password change screen in accordance with a security module.

FIG. 6 is a flowchart of a selection example of authentication processing in accordance with a security module.

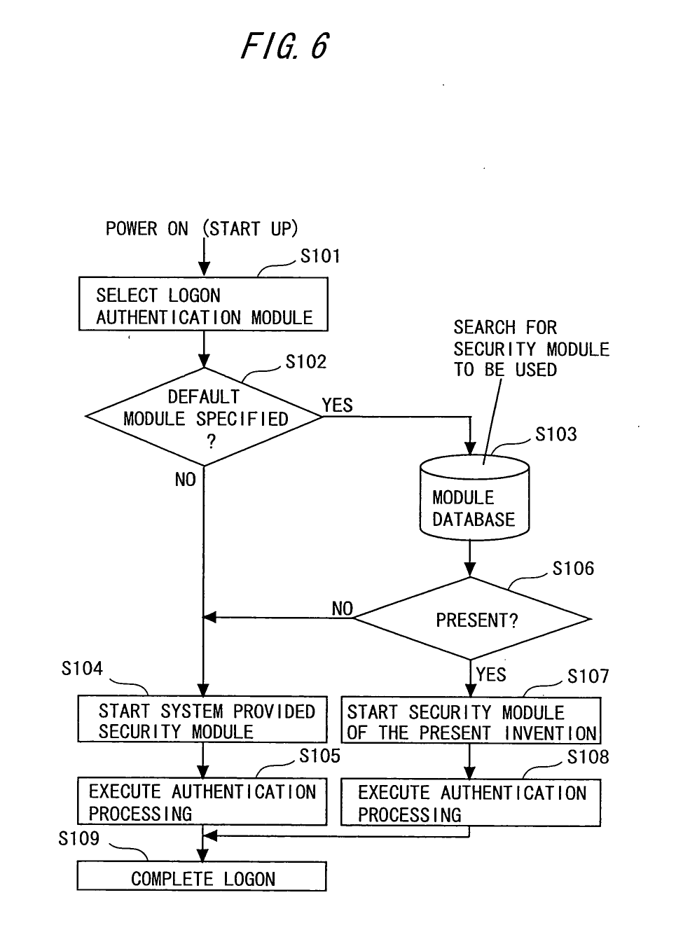

FIG. 7 is a flowchart that shows an example of logon processing in accordance with a security module.

FIG. 8 is a flowchart of valid/invalid determination by a server according to an embodiment of the present invention.

FIG. 9 is a flowchart for a case where a password change request is handled by a security module.

FIG. 10 is a flowchart that shows an example of password change processing in accordance with a security module.

### DETAILED DESCRIPTION OF THE INVENTION

Best modes of carrying out the present invention are explained below with reference to the drawings. Configurations of embodiments below are adopted as examples, and the present invention is not limited by the configurations of the embodiments.

A security module, which is an embodiment of an authentication processing program of the present invention, is applied to logon processing for an OS in a computer in this embodiment. The security module makes it possible to input or update (change) IDs and passwords out of awareness of a user of a computer to which the security module is applied (in an invisible manner). Further, an IC card is used in this embodiment. Information necessary for logon processing, such as a password and an automatic generation algorithm, is stored in the IC card. The IC card protects the stored information by using a PIN (Personal Identification Number). Security of the authentication information (password) is therefore automatically assured for the computer to which the security module is applied, without intervention by a system administrator.

In this embodiment, an authentication processing program is introduced (installed) in a normal computer as a security module such that the computer functions as the information processing apparatus of the present invention. An example of achieving authentication processing using an ID and a password by using the security module and the IC card for OS logon processing of the computer is explained in this embodiment.

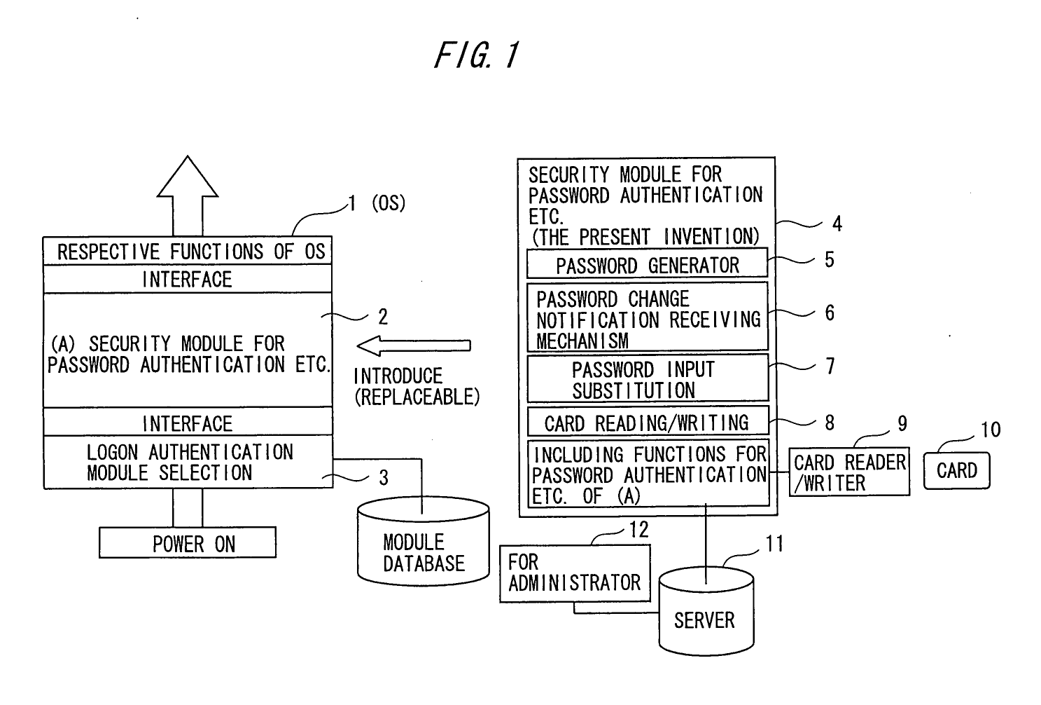

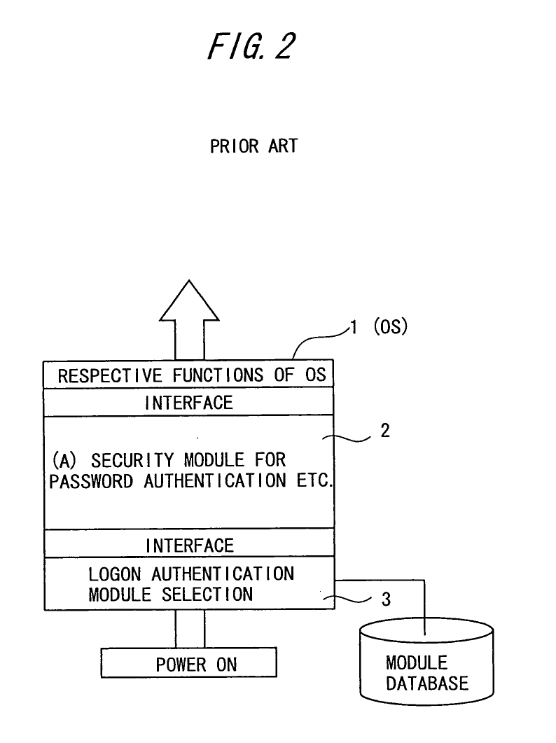

The security module according to this embodiment is achieved by replacing functions relating to user's logon to an OS in a normal computer as shown in FIG. 2 by those shown in FIG. 1 using a computer program. It should be noted that in the computer according to this embodiment, there are no limitations placed on a system of a computer to which the authentication processing program is installed, provided that the computer has a configuration similar to that of FIG. 1.

<Outline of Authentication Processing System>

A computer (not shown) having the functions of the information processing apparatus of the present invention may be configured by using a variety of computer types, such as a personal computer (PC), portable information terminal (PDA), portable telephone, and other specialized computers. The computer is provided with a control apparatus (configured by a CPU, a main memory (RAM or the like), an input/output unit, an OS, device drivers, and the like), a secondary memory (a hard disk or the like), and a communication control apparatus (a network interface apparatus or the like). The CPU loads the authentication processing program, which is stored in the secondary memory, into the main memory and executes the program. The computer thus functions as a computer having the functions of the information processing apparatus of the present invention.

FIG. 1 is a basic functional block diagram for a case in which the security module is applied to a logon portion at the startup of the basic software, OS (operating system) in the computer into which this embodiment is installed (hereinafter, this type of computer is also called a system), which is taken as an example.

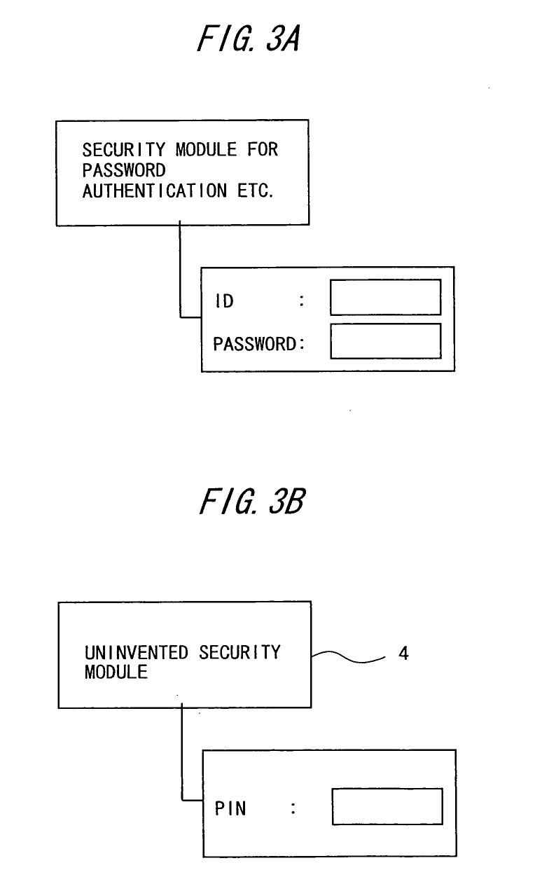

Normally, OS password authentication is performed with a screen that prompts for password input as shown in FIG. 3A, or a password update (change) screen in order to authenticate the user. In contrast, a computer into which the security module is installed dispenses with such a password input screen and the like. A PIN input screen at the time of inserting an IC card as shown in FIG. 3B is displayed instead in this embodiment by the security module that is installed in the computer. That is, a state where password input and updating (changing) processing is displayed to the user during OS logon authentication for the computer.

With logon authentication on a normal computer, an authentication module that is provided to the OS performs authentication processing during the OS logon authentication. In contrast, with the logon authentication of this embodiment a security module 4 replaces an authentication processing module of the OS. Accordingly, the original OS logon screen is no longer displayed on the computer screen. The security module 4 displays a PIN input screen during the OS logon authentication by the security module 4.

The authentication processing system of this embodiment has an automatic password generation and updating system function. The security module (corresponding to the authentication processing program of the present invention) 4 of the authentication processing system realizes computer functions by installing a program that realizes the function in a computer. The authentication processing system is realized by adding the logon processing of the computer to functions of an existing OS authentication processing system 1.

Further, the IC card corresponds to an authentication storage apparatus of the present invention. At this point the security module 4 sends and receives authentication information such as an ID or a password that is stored in an IC card 10 to and from the OS authentication processing system 1. The security module 4 thus performs authentication processing by using the IC card 10, in which the ID and the password are stored, instead of authentication processing based on input by a user in a normal OS.

Further, the security module 4 can also be realized by altering a module 2 (function) relating to password authentication processing in an existing OS program.

For cases where the OS module is altered, the alteration is performed below. That is, information about which programs must be started up at startup of the computer from among programs relating to many processes, which are contained in the OS, is stored in a predetermined definition region of a storage apparatus (a Windows (registered trademark) registry, for example).

In this embodiment, the name of a program that relates to logon authentication processing in a normal OS and that is set in the definition region is changed to the name of the security module 4. The security module 4 can thus replace the normal logon screen with the PIN input screen for logon authentication processing during computer startup. Further, the security module 4 can replace input information with information obtained from the IC card 10 for the ID and the password that are used in OS logon authentication processing, and set the ID and the password in the OS.

The security module can thus correspond to the logon function (password authentication system) in a variety of computers, and is not limited to this embodiment. Further, the security module 4 can also have a function that corresponds to the security module 2 already existing in the OS.

The security module (code number requesting unit, code number checking unit, and authentication information obtaining unit) 4 has a password generator function (corresponding to an authentication information generating unit) 5, a password change notification receiver function 6, a password input substitution function 7, and a card reading and writing function (corresponding to an authentication storage apparatus detection unit, authentication information sending unit, and a function of sending authentication information to the computer in an authentication information updating unit) 8.

Further, a card reader/writer 9 is connected to the security module 4 through hardware of the computer. The IC card 10 is connected to the computer through the card reader/writer 9. The IC card 10 stores the ID and the password in memory (storage medium) that is protected by the PIN. In addition, a management server (hereinafter also referred to simply as a server) 11 that manages information such as a serial ID that is stored in the IC card 10 is connected to the computer.

Further, the security module 4 is resident in the computer system after the OS starts up. Accordingly, the security module 4 can always monitor password change notification from the OS. Further, the security module 4 can detect that the password change notification has been issued.

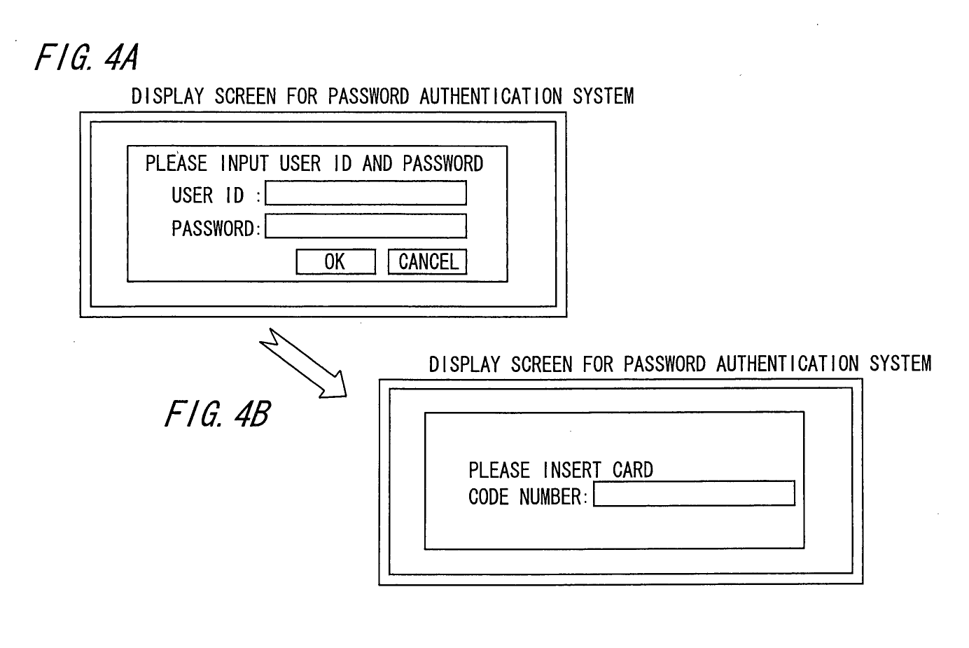

If the security module 4 according to this embodiment is introduced to the authentication processing system 1 in the computer OS, a screen of FIG. 4A is changed to a screen of FIG. 4B, for example. That is, if the security module 4 is introduced, the PIN input screen replaces the screen during OS logon authentication.

The password generator function 5 automatically generates IDs and passwords at random (arbitrarily), which are difficult to decode. It is possible to arbitrarily set the character length of the automatically generated ID and password. It should be noted that, in general, the longer the character length of the password, the more difficult it becomes for another party to decode the password. There is no way to allow an unauthorized administrator or user to learn of the password that is generated by the password generator function 5. The automatically generated password is stored within the IC card 10, and stored in the memory within the card, which is protected by the PIN (code number).

The password generator function 5 registers information about the generated ID and password in the OS authentication processing system 1 of the computer. The password generator function 5 performs this processing so as to enable authentication. Further, the password generator function 5 writes the information about the generated ID and password to the IC card 10. If the IC card 10 is not preset at this point, the screen does not changed from that of FIG. 4A. Input of the ID and the password is then difficult for users that attempt to logon without utilizing the IC card 10. That is, in this case it is difficult to logon the system for users that attempt to connect thereto in an unauthorized way.

The password change notification receiver function 6 receives a password change notification from the OS authentication processing system 1. The password change notification receiver function 6 then notifies the password generator function 5 of the change notification. The password generator function 5 generates and changes a new password based on the change notification.

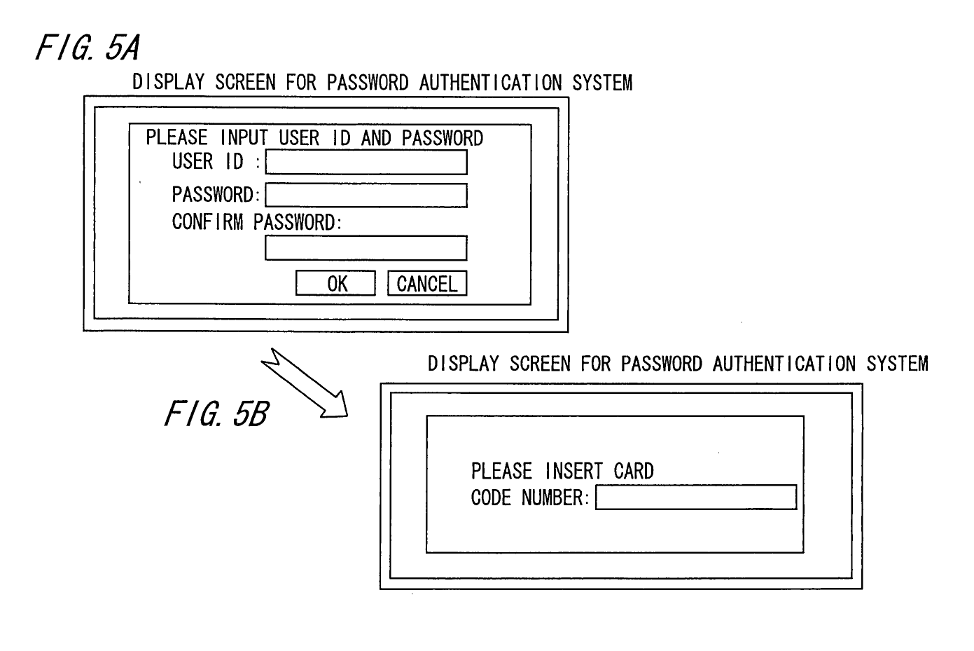

FIGS. 5A and 5B show an example of a new ID and password setting screen with the security module 4 of the OS authentication processing system 1. The computer normally displays a screen for inputting a new user ID and password as shown in FIG. 5A according to OS processing for cases where there is a request for changing the ID or the password.

In contrast, for cases where the security module 4 is introduced to the computer, a PIN input screen that displays “Please insert card.” as shown in FIG. 5B remains as is, even if the password change notification receiver function 6 catches the change notification. However, the password change processing is performed in practice between the security module 4 and the card 10. That is, the reason that the PIN input screen does not change is for making the user unaware of the password change processing. The security module 4 of the OS authentication processing system 1 can thus change the password internally by a user operation of inserting the card alone, without making the user aware that the notification of a password change has been issued.

By using the security module 4 during computer logon authentication, it thus becomes unnecessary for the user to remember a new password with every change. That is, there is no burden on the user to continue managing the password used for logon. The system may therefore normally change the password every day (every hour, every minute), for example, according to the security module 4. Even if a third party attempts to logon the authentication processing system 1 by some means or another, not through the input screen of FIG. 5B, it thus becomes difficult to predict the ever-changing password with this embodiment. That is, the security module 4 can improve security in order to prevent unauthorized logon.

Further, the fact that there is a change request notification is not notified on the screen. Accordingly, it becomes difficult for a user to attempt to intrude the computer in an unauthorized way by properly choosing timing at which a password is changed. That is, the security of the computer can be improved with the security module 4 of the authentication processing system 1 according to this embodiment. It should be noted that it is also possible for the administrator to set the security module 4 to ignore, or set the number of times to ignore, password change notifications from someone other than the user (or the administrator).

The password input substitution function 7 automatically reads in the ID and the password that are stored within the IC card 10 when the IC card 10 is connected to the card reader/writer 9. Further, after reading the ID and the password, the password input substitution function 7 sends the ID and the password to the authentication processing system 1. Accordingly, the user is not made aware of the input processing of the ID and the password according to the password input substitution function 7.

The card reading and writing function 8 performs reading and writing of information, such as the generated user ID, the randomly generated password, and a unique serial ID of the card, from/to the card.

Further, the management server 11 is connected to the OS authentication processing system 1. The management server 11 is provided with serial ID data of the card 10, and a function of managing the card 10. That is, the management server 11 makes the card 10 unusable when the administrator invalidates the serial ID of the card 10 that is stored in the server 11. This type of processing may be performed, for example, in cases where one wishes to invalidate the functions of the card 10 due to theft, loss, and the like. It should be noted that the administrator of the server 11 can only utilize the password invalidation processing function. That is, the user is not informed of the password that is stored within the card 10.

Further, the server 11 determines whether or not the card 10 is a card where writing or reading is permitted. The server 11 makes this determination based on whether or not the serial ID stored in the card 10 is a card serial ID that is permitted for use.

A management user interface 12 is input/output means for the administrator operating the server 11. It should be noted that, in this embodiment, the computer may have management functions for the IC card 10 of the server 11 and the management user interface 12 as well.

<Selection Example of Authentication Processing According to the OS Authentication Processing System 1>

A selection example of logon processing employed in the OS authentication processing system 1 when the user logs on to the computer is explained next while referring to a flowchart.

First, the authentication processing system 1 within the OS performs processing to select the logon authentication module used for the user that logs on (S101). Next, the authentication processing system 1 determines whether or not there is a designation for a default module for the user (S102). For cases where there is no designated module for the user, at this point the authentication processing system 1 starts up a system default security module (S104), and performs authentication processing (S105).

On the other hand, for cases where there is a designation of security module for the user that logs on, the OS authentication processing system 1 searches the module database (DB) for a security module to be used (S103). The OS authentication processing system 1 then determines whether or not there is a security module to be used by the user in the module database (S106).

For cases where a security module to be used for the user is retrieved from the module database, the OS authentication processing system 1 starts up the security module 4 (S107), and performs authentication processing (S108).

When the authentication processing of S105 or S108 is completed by the respective security modules, logon to the OS authentication processing system 1 by the user is complete (S109).

<Logon Processing According to the Security Module>

An example of logon processing according to the security module 4 of the OS authentication processing system 1 is explained next.

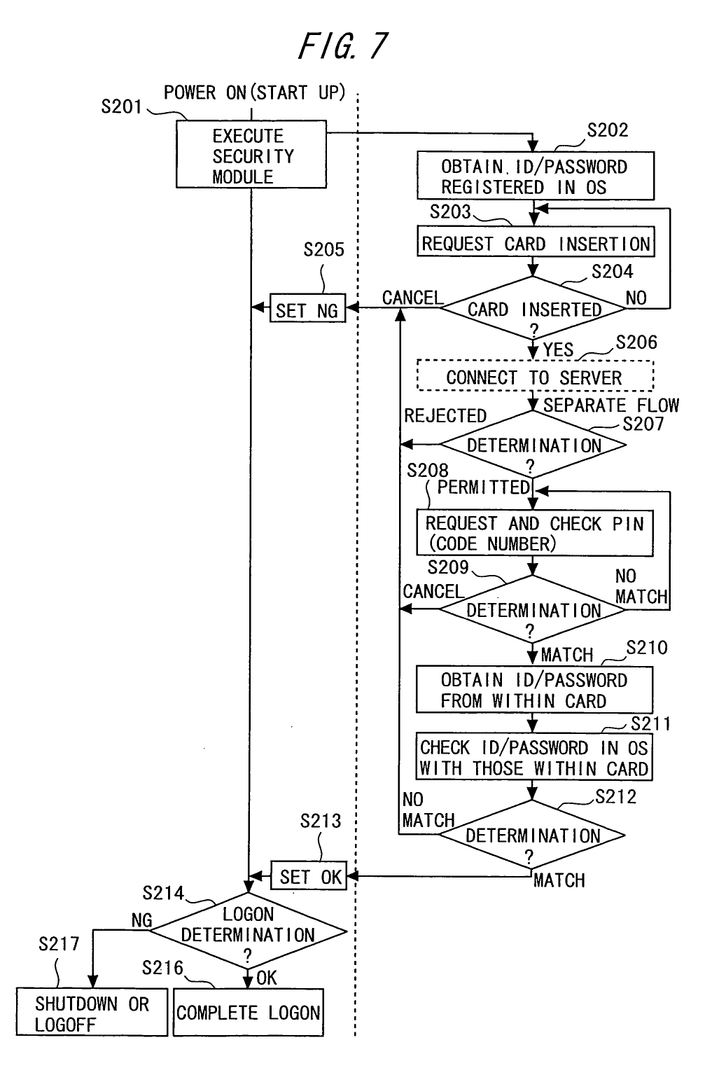

FIG. 7 is a flowchart that shows an example of logon processing by the security module 4 of the OS authentication processing system 1.

When a power for the computer is turned on and the system is started up, the functions of the security module 4 are executed by the functions of the OS authentication system 1 (S201). The security module 4 obtains the established user ID and the established password that are registered in the OS from a storage apparatus (not shown) (S202).

The security module 4 requests that a card be inserted in order to obtain information on the ID and the password within the card 10 from the user who is requesting authentication (S203). The computer screen at this point takes on the state of FIG. 4B.

The security module 4 determines whether or not the IC card 10 has been inserted into the card reader/writer 9 of the computer (S204). For cases where the user has cancelled logon processing at this point, the security module 4 determines that logon processing has not been completed normally, and sets NG for the logon processing (S205). Further, for cases where the IC card 10 has not been inserted into the card reader/writer 9, the security module 4 repeatedly requests that the user inserts the card into the computer.

When the IC card 10 is inserted into the card reader/writer 9, the security module 4 connects to the server 11 and sends information of the IC card 10 (such as the serial ID) to the server 11 (S206). The server 11 determines whether or not the IC card 10 is valid for the OS authentication processing system 1 based on the information that is sent, thus determining whether the card is valid or invalid.

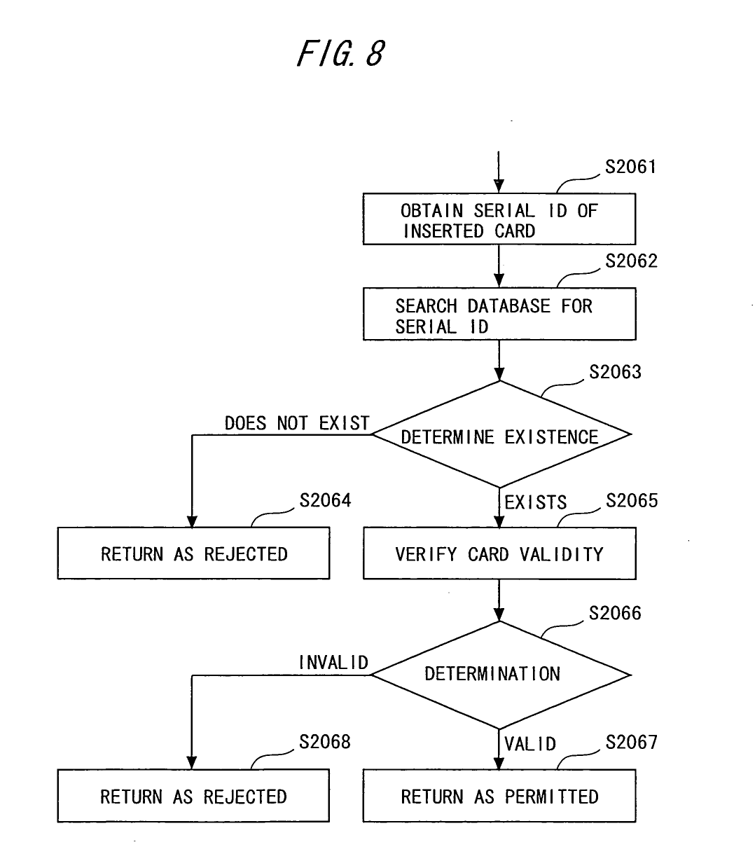

FIG. 8 is a flowchart for determining with the server 11 whether the IC card 10 is valid or invalid for the computer in this embodiment.

The server 11 obtains the serial ID of the IC card 10 that has been inserted into the card reader/writer 9 of the OS authentication processing system 1 from the security module 4 (S2061).

The server 11 searches for the serial ID obtained from the database (not shown), which corresponds to the IC card 10 (S2062). The server 11 then performs processing for determining whether or not the serial ID of the IC card 10 exists (S2063). It should be noted that the information used in determining whether the IC card 10 is valid or invalid at this time is not limited to the serial ID. For example, if substitute information for the serial ID is available, the server 11 may also utilize that information.

For cases where the corresponding serial ID is not found in the database in S2063, the server 11 returns information to the OS authentication processing system 1 for rejecting the IC card 10 as not being that of a legitimate user (S2064).

Further, for cases where the corresponding serial ID is found in the database in S2063, the server 11 verifies whether or not the IC card 10 is a valid card based on database information (S2065).

The server 11 determines whether or not the IC card 10 is valid for the OS authentication processing system 1 based on the database information, thus performing determination of validity or invalidity (S2066). The server 11 then sends (returns) a result that the card is valid (permitted) or invalid (rejected) to the OS authentication processing system 1 (S2067, S2068). It should be noted that the computer may have the management functions of the IC card 10 of the server 11 and the management user interface 12 as well.

The security module 4 determines whether or not a response from the server 11 regarding the IC card 10 indicates that the card is valid (S207). For cases whether the response is that the IC card 10 is permitted for use in logon in processing of S207, the security module 4 checks the code number with respect to the PIN (code number) that is input in accordance with insertion of the IC card 10 (S208). The OS authentication processing system 1 can thus obtain information from the IC card 10 only when the code number of the IC card 10 matches.

Further, for cases where there is a response indicating the rejection with respect to the IC card 10 in processing of S207, the security module 4 sets an NG determination and responds to the OS (OS authentication processing system 1) for canceling the user logon processing based on the IC card 10. After receiving the NG determination, the OS performs logon determination (S214). The OS (OS authentication processing system 1) performs shutdown or logoff based on the determination (S217).

For cases where it is possible to obtain information from the IC card 10, the security module 4 obtains the ID and the password within the IC card 10 (S210). The security module 4 then checks the ID and the password stored in the IC card 10 with the ID and the password obtained from the OS (S211).

The security module 4 performs processing for determining results of checking the ID and the password of the IC card 10 with those of the OS (S212). If the IDs and the passwords do not match at this point, the security module 4 sets an NG determination in the OS for canceling logon processing (S205). After receiving the NG determination, the OS performs logon determination (S214). The OS (OS authentication processing system 1) performs shutdown or logoff based on the determination (S217).

Further, for cases where the IDs and the passwords match in S212, the ID and the password within the IC card 10 are sent to the OS (OS authentication processing system 1) along with a response indicating logon determination OK (processing similar to pressing an OK button during normal logon operations).

Processing like that described above is possible in the security module 4 of the OS authentication processing system 1 for reasons described below. That is, an interface for obtaining and checking the ID and the password so that a normal computer OS will cooperate with an external module is provided. The security module 4 of the OS authentication processing system 1 performs processing for sending and receiving the ID and the password by utilizing the interface. It should be noted that, as discussed above, the checking processing described above may also be performed within a module of the OS, provided that its configuration allows replacement of a security module in the OS as is.

<Password Change Processing by the OS Authentication Processing System 1>

Next, explanation is given of processing for cases where a password change request is received during logon in the security module 4 of the OS authentication processing system 1.

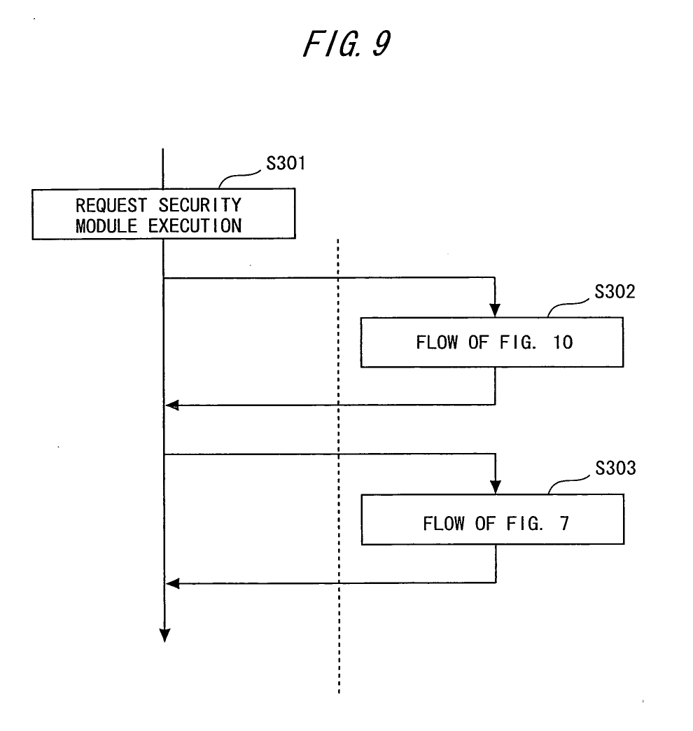

FIG. 9 is a flowchart for a case where the security module 4 of the OS authentication processing system 1 handles a password change request.

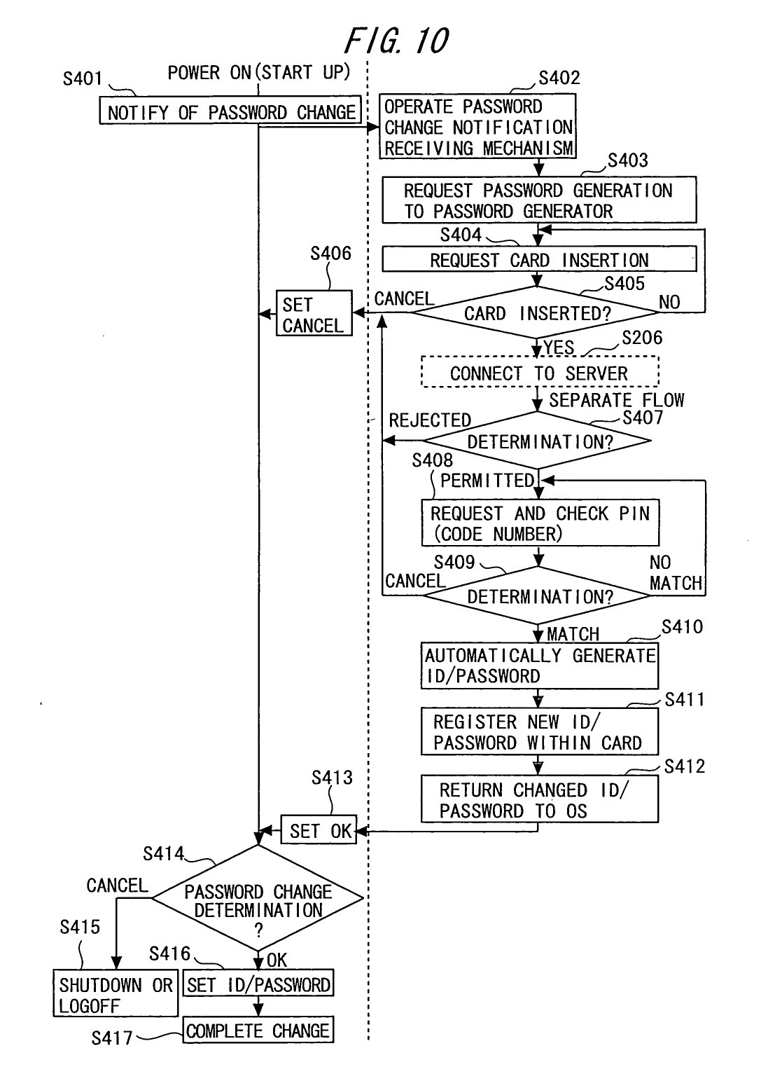

For cases where the password change notification is received in this embodiment, the security module 4 executes the logon processing (S301), performs password change processing described hereinafter as shown in FIG. 10 (S302), and then performs the OS logon processing described above as shown in FIG. 7 (S303).

FIG. 10 is a flowchart that shows an example of password processing according to the security module 4 of the OS authentication processing system 1.

When a power is turned on and the OS authentication processing system 1 starts up, a password change notification (S401) is sent to the password change notification receiver function 6 by operations of the user. The password change notification receiver function 6 operates in order to receive the password change notification (S402).

The password change notification receiver function 6 sends a password generation request to the password generator 5 based on the password change notification (S403). The password generator 5 makes a request to the user to insert the IC card 10 in order to obtain information on the ID and the password within the IC card 10 for the OS authentication processing system 1 (S404). At this point the computer screen takes on the state of FIG. 5B.

The password generator 5 determines whether or not the IC card 10 has been inserted into the card reader/writer 9 (S405). For cases where the user cancels the logon processing at this point, the security module 4 determines that logon processing has not been completed normally. The security module 4 then sets the logon processing to be cancelled for this case (S406). Further, for cases in which the IC card 10 has not been inserted into the card reader/writer 9, the password generator 5 repeatedly requests that the card be inserted.

Provided that the IC card 10 is inserted into the card reader/writer 9, the password generator 5 connects to the server 11 and sends information from the IC card 10 (such as the serial ID) to the server 11 (S206). The server 11 determines whether or not the IC card 10 is valid for the OS authentication processing system 1, thus performing the determination of validity or invalidity as shown in FIG. 8.

The security module 4 determines whether or not the response from the server 11 with respect to the IC card 10 indicates that the card is valid (S407). For cases where there is a response indicating that the IC card 10 is permitted for use in logon in processing of S407, the security module 4 performs code number checking with respect to the PIN (code number) that is input in accordance with insertion of the IC card 10 (S408). The password generator 5 can thus obtain the information within the IC card 10 only when the code number of the IC card 10 matches.

Further, for cases where there is a refusal response with respect to the IC card 10 in the processing of S407, the security module 4 makes a cancel determination for canceling the user logon processing based on the IC card 10, and responds to the OS. After receiving the Cancel determination, the OS performs change determination (S414). The OS (OS authentication processing system 1) performs shutdown or logoff based on the change determination (S415)

For cases in which it is possible to obtain the information from the IC card 10, the password generator 5 automatically generates an ID and a password for the IC card 10 (S410). There if a method in which, for example, an automatic password generation algorithm is obtained from the IC card 10, and a password is randomly generated based on the algorithm, as a method for automatic password generation at this point. Further, utilizing the date and time when the card was inserted, information in the card, and the like can be used as the information that becomes a basis upon which the password generator 5 randomly generates the password.

The password generator 5 then registers the newly automatically generated ID and password in the IC card 10, replacing the ID and the password that have been stored in the IC card 10 with the new ones (S411). Further, the password generator 5 also registers new ID and password for the OS authentication processing system 1 (S412). Further, the password generator 5 notifies the OS authentication processing system 1 that ID and password change processing is judged as OK. After receiving an OK determination from the password generator 5, the OS authentication processing system 1 sets an OK determination (S413).

The OS authentication processing system 1 determines whether to change the ID and the password that are registered in the IC card 10, and the ID and the password for the OS (S414). If the IDs and the passwords do not match at this point, password change determination is performed based on a cancel determination (S414). The OS (OS authentication processing system 1) then performs shutdown or logoff based on the determination (S415). Further, for cases where the IDs and the passwords match, password change determination is performed based on the OK determination (S414). The OS authentication processing system 1 then sets the new ID and the new password in the OS (S416), and completes password change processing (S417).

<Modified Example>

In this embodiment, the authentication processing according to the present invention is explained with an example of processing that is mainly performed within the computer during logon processing to the computer OS. The present invention is not limited to this example, however. For example, logon processing that is similar to that of this embodiment can also be performed within the IC card.

The password generator 5 may also perform ID and password update periodically.

Plural types of authentication information may also be stored in the IC card.

Authentication information relating to the computer OS is explained in this embodiment, but the present invention is not limited to this. For example, authentication information that relates to the computer may also be used. Alternatively, authentication information that relates to a program being executed on another computer capable of communication with the computer may also be used. In this case the other computer sends the authentication information to the computer, and the computer temporarily stores the authentication information in a storage apparatus. Further, during updating of the authentication information, the computer sends the updated authentication information to the other computer, requesting that the authentication information be updated.

Further, the authentication processing system 1 and the password generator function 5 may also be within the IC card 10.

As described above, according to the present invention, it is possible to provide an authentication technique that can perform generation of robust authentication information without making the user aware of this. Further, according to the present invention, it is possible to provide an authentication technique that can perform reliable management of authentication information without making the user aware of this. In addition, according to the present invention, it is possible to provide an authentication technique that can perform authentication information generation and modification processing without making another aware of this.

1. An information processing apparatus, comprising:
an authentication information obtaining unit that obtains authentication information from an authentication storage apparatus when code information input by a user matches established code information;
a storage unit that stores established authentication information;
an authentication unit that performs authentication by comparing the authentication information and the established authentication information;
an authentication information generating unit that generates new authentication information; and
an authentication information updating unit that updates the authentication information of the authentication storage apparatus and the established authentication information of the storage unit into new authentication information when the authentication by comparing the authentication information with the established authentication information is normal.

2. An information processing apparatus according to claim 1, wherein the authentication information updating unit periodically updates the authentication information.

3. An information processing apparatus according to claim 1, the authentication storage unit stores plural pieces of the authentication information.

4. An information processing apparatus according to claim 1, wherein the authentication information is authentication information necessary for using the information processing apparatus.

5. An information processing apparatus according to claim 1, wherein the authentication information is authentication information necessary for using a program to be executed by the information processing apparatus.

6. An information processing apparatus according to claim 1, wherein the authentication information is authentication information necessary for using a program to be executed by another information processing apparatus with which the information processing apparatus can communicate.

7. An information processing apparatus according to claim 1, wherein the authentication storage apparatus is a portable storage medium that can be mounted to and removed from a reading apparatus.

8. An information processing apparatus according to claim 7, wherein an instruction to mount the portable storage medium to the reading apparatus is issued to the user when the authentication information updating unit performs updating.

9. An authentication method for executing the steps of:
obtaining authentication information from an authentication storage apparatus when code information input by a user matches established code information;
performing authentication by comparing the authentication information and the established authentication information in a storage unit;
generating new authentication information; and
updating the authentication information of the authentication storage apparatus and the established authentication information into new authentication information when the authentication by comparing the authentication information with the established authentication information is normal.

10. An authentication method according to claim 9, wherein the step of updating the new authentication information includes periodically updating the authentication information.

11. An authentication method according to claim 9, wherein the authentication storage apparatus stores plural pieces of the authentication information.

12. An authentication method according to claim 9, wherein the authentication information is authentication information necessary for using an information processing apparatus.

13. An authentication method according to claim 9, wherein the authentication information is authentication information necessary for using a program to be executed by an information processing apparatus.

14. An authentication method according to claim 9, wherein the authentication information is authentication information necessary for using a program to be executed by another information processing apparatus with which an information apparatus can communicate.

15. An authentication method according to claim 9, wherein the authentication storing apparatus is a portable storage medium that can be mounted to and removed from a reading apparatus.

16. An authentication method according to claim 15, wherein an instruction to mount the portable storage medium to the reading apparatus is issued to the user when the step of updating the new authentication information is performed.

17. An authentication storage apparatus, comprising:
a storage unit that stores code information and authentication information used in authenticating a user;
a code information receiving unit that receives input code information from an information processing apparatus;
a code information checking unit that compares the code information with the input code information;
an authentication information sending unit that sends the code information to the information processing unit when the checking by the authentication information checking portion is normal;
an authentication information generating unit that generates new authentication information; and
an authentication information updating unit that updates the authentication information into the new authentication information, and sends the new authentication information to the information processing apparatus when authentication performed by the information processing apparatus using the authentication information is normal.

18. An authentication storage apparatus according to claim 17, wherein the authentication information updating unit periodically updates the authentication information.

19. An authentication storage apparatus according to claim 17, wherein the information processing apparatus stores plural pieces of the authentication information.

20. An authentication storage apparatus according to claim 17, wherein the authentication information is authentication information necessary for using the information processing apparatus.

21. An authentication storage apparatus according to claim 17, wherein the authentication information is authentication information necessary for using a program to be executed by the information processing apparatus.

22. An authentication storage apparatus according to claim 17, wherein the authentication information is authentication information necessary for using a program to be executed by another information processing apparatus with which the information processing apparatus can communicate.

23. An authentication storage apparatus according to claim 17, wherein said authentication storage apparatus is a portable storage medium that can be mounted to and removed from a reading apparatus.

24. An authentication storage apparatus according to claim 23, wherein an instruction is issued to the user to mount the portable storage medium to the reading apparatus when the authentication information updating unit performs updating.
